(19) United States
(12) Patent Application Publication
(10) Pub. No.: US 2020/0196650 A1
(43) Pub. Date: Jun. 25, 2020

(54) SEASONING COMPOSITION CONTAINING FOAMING AGENTS

(71) Applicant: Broth Bomb LLC, Lakeland, FL (US)

(72) Inventors: Andrew Dundas Laurent, St Petersburg, FL (US); Renee Nicole Laurent, Winter Haven, FL (US)

(73) Assignee: Broth Bomb LLC, Lakeland, FL (US)

(21) Appl. No.: 16/720,501

(22) Filed: Dec. 19, 2019

Related U.S. Application Data
(60) Provisional application No. 62/781,663, filed on Dec. 19, 2018.

(51) Int. Cl. A23L 29/00; A23P 10/25

(52) U.S. Cl. CPC A23L 29/035; A23P 10/25; A23L 29/015

(57) ABSTRACT

A seasoning composition comprising one or more additives, a base, and a dried acid. The base and the dried acid have an effervescent effect when added to a quantity of water to improve the desirability of a recipe, increasing the breakdown of foodstuff in the recipe, and enhancing the flavor uptake of the foodstuff within the recipe.

### CROSS REFERENCE TO RELATED APPLICATIONS

The application claims priority and benefit to U.S. provisional application Ser. No. 62/781,663 filed on Dec. 19, 2018, which is incorporated herein by reference.

### TECHNICAL FIELD

The present system relates generally to the culinary arts. More particularly, the present system relates ready-to-use seasoning compositions for use in the culinary arts.

### BACKGROUND

The culinary arts are a common pastime for many people around the world. In some cases, preparing a meal can become complicated and expensive depending on the variety and amounts of seasonings to be used in the particular recipe, reducing the likelihood that the recipe is executed correctly.

To reduce the need to buy large numbers of ingredients which are only used sparingly, companies have created seasoning blends tailored to specific flavor profiles. The most common formats in which seasonings are provided include powders, granulates, and cubes. The powders and granulates are generally offered in jars or similar containers while the cubes are individually wrapped.

While the above greatly benefit the at-home chef, many ingredients are not readily integrated into the preparation of the recipe by simply adding the ingredients into a broth. Special consideration should be made for specific ingredients which do readily not acquire the flavor profile of seasonings, such as beans and various vegetables.

In many cases, recipes may be less desirable to a certain populace, such as children. Increasing the child's interaction with the preparation of the recipe may enhance their desire to try new foods. The current arts do not provide seasoning compositions which enhance the interaction during preparation in addition to the flavor of the recipe.

Accordingly, there exists a need in the art to provide an apparatus and/or system that enhances the interaction of seasoning compositions during preparation as well as adding flavor to the recipe.

### SUMMARY

Embodiments disclosed herein provide a seasoning composition comprising one or more additives, a base (typically a dried base), and a dried acid. The base and the dried acid have an effervescent effect when added to a quantity of water to improve the desirability of a recipe, increasing the breakdown of foodstuff in the recipe, and enhancing the flavor uptake of the foodstuff within the recipe.

One element of the present disclosure relates to dried spice and herb mixtures that fizz when put into soups and stews. With the combination as herein described, the combination distributes spices into a pot of food more effectively and tenderizes and cooks beans faster. A combination of dried food grade ingredients (herbs, spices, salt, sweetener, extracts, powders, flours, and/or oil with a food grade dry acid, such as citric acid, ascorbic acid, or cream of tartar, and a dry base, such as, baking soda and/or calcium carbonate, to create a product to be used in meals with higher liquid content, like but not limited to, soups, broths, and stews. Various other examples and embodiments are discusses in the following. The combination as herein described achieves three unexpected and desirable results. First, the combination as herein described creates a bubble, foam, and/or fizz creating an enjoyable experience for the user. Second, the combination as herein described prevents clumping and more effectively distributes the herbs, spices, sugar, oil, and/or flour when added to a pot containing liquid and/or food. Third, the combination as herein described infuses and immerses the pot of food with carbon dioxide and water, which are byproducts of the reaction of the dry acid and base in a liquid. As is sodium citrate, a common food acidity regulator. Some of the high pH ingredients like sodium bicarbonate will interact with the food, especially the skins of the beans. Research shows soaking beans in baking soda make the protein more absorbable. However, soaking beans means discarding water resulting in waste and additional time.

In one aspect, the one or more additives include at least one of the following: one or more water-insoluble components, one or more water-soluble components, one or more buffers, one or more thickeners, one or more flavorants or flavorings, one or more sweeteners, one or more processing aids, and one or more surfactants. The addition of additives to the composition is dependent on the recipe being executed.

In one aspect, the base is sodium bicarbonate while the dried acid is citric acid. The sodium bicarbonate and citric acid may be provided as food-grade sodium bicarbonate and food-grade citric acid.

In another aspect, the food-grade sodium bicarbonate and the food-grade citric acid are provided in a 2:1 ratio respectively. In other embodiments, the ratio may include a range between 2:3 and 2:1 respectively.

In one aspect, the first layer includes the base, the dried acid and the one or more additives. The second layer may also include one or more additives.

The composition can be provided in a plurality of different forms, including various shapes, sizes, and configurations. In some embodiments, the remainder or remnants from the formed composition into a shape is used in an instant type food packaging. In this embodiment, remnants and extra pieces from the main formed shape production are placed at the bottom of a noodle cup, or other food. The user can then add water or other liquid to the pre-made food cup in preparation for consumption. The remnants will produce the same result as the formed shape as discussed herein.

In one aspect, the effervescent effects of the sodium bicarbonate can aid in the desirability of the foodstuff contained within the recipe by providing a more interactive and entertaining process of preparing the recipe. The effervescent effects may be most desired by children and populations sensitive to certain foodstuff.

### BRIEF DESCRIPTION OF THE DRAWINGS

n/a

### DETAILED DESCRIPTION

The specific details of the single embodiment or variety of embodiments described herein are set forth in this application. Any specific details of the embodiments are used for demonstration purposes only, and no unnecessary limitation or inferences are to be understood therefrom. It is noted that the embodiments reside primarily in combinations of components related to the composition.

In some embodiments, a dried seasoning composition is provided which includes various ingredients in addition to an amount of a base, such as sodium bicarbonate and an amount of a dry acid, such as citric acid. When mixed with water, the dry acid and base react to form carbon dioxide, water, and a sodium-based food additive. In an embodiment wherein citric acid is used, sodium citrate is produced. The sodium bicarbonate facilitates the breakdown of some foods, such as beans, providing a favorable texture and enhanced flavor. The addition of citric acid acts as a preservative for the composition in addition to acting as a buffering agent enhancing flavor and tartness. The composition can be added to various foodstuff including soups, stews, warm beverages, and baked goods, in addition to other foodstuff configurations.

The utilization of sodium bicarbonate and citric acid provides a foaming agent having an effervescent effect when added to a liquid, such as a stew, or soup, or warm beverages. The effervescent effect may aid in the desirability of the foodstuff for certain demographics such as children. Effervescence may also enhance the preparation of food by increasing the uptake of flavor compounds into various components of a recipe.

Various foaming agents can be utilized in addition to or in place of sodium bicarbonate and citric acid. For example, more mild foaming agents may be preferred such as cream of tartar (acid) and calcium carbonate (base).

In some embodiments, the composition is provided with a dry acid, such as citric acid. A base is also provided, such as sodium bicarbonate. In one example, the dry acid and base can be mixed by combining one part of the dry acid with two parts of the base. In one example, the composition may further include flour to provide a thickening agent to a recipe. In another example, the dry acid and base are combined with a powdered fat and/or a sugar which can be added to a liquid to make a particular warm beverage.

The ratio of sodium bicarbonate and citric acid (or similar bases and dry acids) is between 2:3 and 2:1 depending on the acidity of the ingredients in the recipe.

The composition can include various water-insoluble components, water-soluble components, buffers, thickeners, flavorants, sweeteners, processing aids, and surfactants (collectively referred to as “additives”).

As used herein, the term “water-insoluble components” refers to those materials that are not soluble or miscible in water but are typically dispersed in the aqueous phase and are visible when viewed through a microscope. The water-insoluble components typically include fat/oil components, microparticulate components, and emulsifiers, and may also include flavorants and microcrystalline cellulose. One of ordinary skill in the art will readily understand that the water-insoluble components may be derived from multiple source ingredients (e.g., the fat/oil component may come from a creamer, whole milk, and/or 2% fat milk), and one source ingredient may contribute to multiple water-insoluble components (e.g., a creamer may contribute to the fat/oil component and the emulsifier).

As used herein, the term “water-soluble component” refers to those materials that are soluble or completely miscible in water and are not visible when viewed through a microscope. The water-soluble components typically include the sweeteners, buffers derived from salts (i.e., sodium bicarbonate and dipotassium phosphate), acids (i.e., citric acid), thickeners, such as hydrolyzed starches (e.g., maltodextrins), pre-gelatinized starches, chemically modified food starches, hydrocolloid gums (e.g., carboxymethylcellulose), and processing aids (e.g. flow aids such as silicon dioxide), as well as soluble beverage components and flavorants. One of ordinary skill in the art will readily understand that the water-soluble components may be derived from multiple source ingredients (e.g., a foam stabilizer may come from a creamer and a foaming agent), and one source ingredient may contribute to multiple water-soluble components (e.g., skim milk may contribute to the sweetener (lactose) and milk solids component).

In some embodiments, thickeners are utilized in the composition. The use of thickeners can be especially useful when the composition is utilized in a beverage. These thickening agents include natural and synthetic gums and natural and chemically modified starches. Suitable gums include locust bean gum, guar gum, gellan gum, xanthan gum, gum ghatti, modified gum ghatti, tragacanth gum, carrageenan, and/or anionic polymers derived from cellulose such as carboxymethylcellulose, sodium carboxymethylcellulose, as well as mixtures of these gums. Suitable starches include, but are not limited to, pregelatinized starch (e.g., corn, wheat and tapioca), pregelatinized high amylose content starch, pregelatinized hydrolyzed starches (e.g., maltodextrins and corn syrup solids), chemically modified starches such as pregelatinized substituted starches (e.g., octenyl succinate modified starches such as N-Creamer, N-Lite LP, and TEXTRA, manufactured by National Starch), as well as mixtures of these starches. It is particularly preferred that thickening agents be predominantly made from starches and that no more than 20%, most preferably no more than 10%, of the thickener be made from gums.

In some embodiments, the composition can include sweeteners such as sucrose, fructose, dextrose, maltose, lactose, high fructose corn syrup solids, invert sugar, sugar alcohols, including sorbitol, as well as mixtures of these sugars and sugar alcohols. To deliver lower levels of solids per dosage, it is particularly preferred to use a higher intensity sweetener with the sugar or sugar alcohol.

In some embodiments, processing aids can be utilized in the composition. Processing aids can include flow aids, anti-caking agents, dispersing aids, and the like. Particularly preferred are flow aids such as silicon dioxide and silica aluminates. Starches, aside from those thickening agents, can also be included to keep the various ingredients from caking.

Some embodiments include flavorant's other than those inherently present in the recipe. The flavored component may be found in either the water-soluble component, the water-insoluble component, or both. Preferably, such flavors are obtained from encapsulated or liquid flavors. These flavors can be natural or artificial in origin. For soups and stews, some flavorants can include garlic, onion, oregano, bay leaf, allspice, caraway seed, cardamom, cayenne pepper (in addition to other peppers), cinnamon, coriander seed, cumin, fennel seed, ginger, nutmeg, paprika, peppercorns, rosemary, saffron, sage, star anise, turmeric, thyme, basil, chives, cilantro, dill, marjoram, and mint among other spices used in the culinary arts. Preferred flavors, or mixtures of flavors which may be most suitable for a dessert or beverage can include almond nut, anisette, cappuccino, mint, cinnamon, cinnamon almond, peppermint stick, pistachio, sambuca, apple, chamomile, cinnamon spice, creme, creme de menthe, vanilla, French vanilla, Irish creme, peppermint, lemon, macadamia nut, orange, orange leaf, peach, strawberry, grape, raspberry, cherry, coffee, chocolate, cocoa, mocha and the like, and any mixtures thereof, as well as flavorant/aroma enhancers such as acetaldehyde, herbs, spices, as well as any mixtures thereof. The seasoning composition can be provided as a single-use and/or single serving product which may be individually packaged or packaged in bulk.

During formulation of the seasoning composition, the sodium bicarbonate and citric acid can be provided in a first layer, while the flavorants are provided in a second layer. In some recipes, it may be preferred for the flavorants to be provided on the exterior layer and the sodium bicarbonate and citric acid provided in an interior layer. Conversely, in some recipes, the flavorants are provided in an interior layer while the sodium bicarbonate and citric acid are provided in an exterior layer for faster initiation of the effervescent effects.

In some embodiments, the composition is provided in a form, such as a shape. The form can include a plurality of layers configured to provide the effervescent effects at varying time intervals. Forms can include cubes, spheres, or other geometric shapes.

Many different embodiments have been disclosed herein, in connection with the above description. It will be understood that it would be unduly repetitious and obfuscating to literally describe every combination and subcombination of these embodiments. Accordingly, all embodiments can be combined in any way and/or combination, and the present specification, shall be construed to constitute a complete written description of all combinations and subcombinations of the embodiments described herein, and of the manner and process of making and using them, and shall support claims to any such combination or subcombination.

The method of manufacture includes the steps of:
1. Combine cooking ingredients with a food grade dry powdered base.
2. Wet mixture very slightly with a mist of liquid that has a near neutral pH.
3. Add a dry powdered food grade acid.
4. Add the mixture to a form of any shape.
5. Remove and dry to solidify before packaging.

In some embodiments, the combination include multilayers. One mixture is first added to the form with a depreciation left for further mixtures to be placed inside. In some applications this will allow for less volume of certain ingredients to be used that do not add to flavor but will still satisfy the other purposes. In another embodiment, the method will not wet and form the mixture but to sell it as a loose mixture.

In most embodiments, the total ratio of cooking ingredients to foaming agents to achieve both a pleasant taste and enough foam can range between 25% to 75% of either depending on layering. The ratio of the acid and base is a range from 25-75% acid to 75-25% base depending on the intended acidity of the fully prepared recipe for which the herb and spice mixture is intended.

It will be appreciated by persons skilled in the art that the present embodiment is not limited to what has been particularly described hereinabove. A variety of modifications and variations are possible in light of the above teachings without departing from the following claims.

It is noted that the terms “substantially” and “about” may be utilized herein to represent the inherent degree of uncertainty that may be attributed to any quantitative comparison, value, measurement, or other representation.

These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter.

Moreover, although various aspects of the claimed subject matter have been described herein, such aspects need not be utilized in combination.

It is therefore intended that the appended claims cover all such changes and modifications that are within the scope of the claimed subject matter.

What is claimed is:

1. A seasoning composition comprising:
one or more additives;
a base; and
a dried acid, the base and the dried acid creating an effervescent effect when added to a quantity of water.

1. position of claim 1, wherein the one or more additives include at least one of the following: one or more water-insoluble components, one or more water-soluble components, one or more buffers, one or more thickeners, one or more flavorants, one or more sweeteners, one or more processing aids, and one or more surfactants.

3. The composition of claim 1, wherein the base is sodium bicarbonate.

4. The composition of claim 3, wherein the dried acid is citric acid.

4. position of claim 4, wherein the sodium bicarbonate is food-grade sodium bicarbonate, and the citric acid is food-grade citric acid.

6. The composition of claim 5, wherein the food-grade sodium bicarbonate and the food-grade citric acid are provided at a ratio between 2:3 and 2:1 respectively.

7. The composition of claim 1, wherein the one or more additives, the base and the dried acid are provided in a first layer, and wherein the one or more additives are also provided in a second layer.

8. The composition of claim 1, provided in a plurality of forms.

9. A seasoning composition comprising:
one or more additives;
food-grade sodium bicarbonate; and
food-grade citric acid, the food-grade sodium bicarbonate and the food-grade citric acid having an effervescent effect when added to a quantity of water, the sodium bicarbonate and chemical reaction facilitating the breakdown of a foodstuff and facilitating the uptake of the one or more additives.

10. The composition of claim 9, wherein the one or more additives include at least one of the following: one or more water-insoluble components, one or more water-soluble components, one or more buffers, one or more thickeners, one or more flavorants, one or more sweeteners, one or more processing aids, and one or more surfactants.

11. The composition of claim 9, wherein the food-grade sodium bicarbonate and the food-grade citric acid are provided at a ratio between 2:3 and 2:1 respectively.

12. The composition of claim 9, wherein the food-grade sodium bicarbonate, one or more additives, and the food-grade citric acid are, provided in a first layer, and wherein the one or more additives are also provided in a second layer.

13. The composition of claim 9, provided in a plurality of forms.

14. The composition of claim 9 wherein all ingredients of the seasoning composition are compressed together and solidified to form a predetermined shape.

15. A method of using the composition of claim 9 including the steps of:
immersing the composition n a volume of food containing water;
dissolving the composition so that the food-grade sodium bicarbonate and the food-grade citric acid can interact wherein said interaction produces carbon dioxide, the carbon dioxide, promoting food tenderness.

16. A method of manufacturing a seasoning for use with food, the method comprising the steps of:
combining food additives with a food-grade sodium bicarbonate;
wetting the combination of the food additives and the food-grade sodium bicarbonate with a mist of liquid with a generally neutral pH level;
adding a dry powdered food-grade citric acid;
forming the mixture to form a predetermined shape; and
drying the mixture to solidify the combination and said predetermined shape.
